(19) United States
(12) Patent Application Publication
(10) Pub. No.: US 2005/0015407 A1
(43) Pub. Date: Jan. 20, 2005

(54) System and method of relational configuration mirroring

(75) Inventors: Lu Nguyen, San Jose, CA (US); Mark James Seaman, San Jose, CA (US); Syed Mohammad Amir Ali Jafri, Mountain View, CA (US)

Correspondence Address: HARRINGTON & SMITH, LLP, 4 RESEARCH DRIVE, SHELTON, CT, 06484-6212, US

(73) Assignee: INTERNATIONAL BUSINESS MACHINES CORPORATION

(21) Appl. No.: 10/622,277

(22) Filed: Jul. 17, 2003

(51) Int. Cl. G06F 12/00

(52) U.S. Cl. 707/200

(57) ABSTRACT

A method of automating the process of creating a remote mirror of a relational database management system (RDBMS) includes discovering storage configuration and database layout at a primary database, relaying this information to a backup storage subsystem, monitoring that database and storage systems for changes and conveying storage and/or database changes to the backup storage subsystem. A self-configuring backup mirroring system for dynamic relational configuration includes a source system monitoring one or more storage servers and a computer system running a RDBMS. A backup system provides a disaster recovery environment for the source system wherein backup storage components duplicate the source storage components. The backup system may be used to reconstruct the source storage system if necessary. Finally, software agents run at both the source and backup systems.

### FIELD OF THE INVENTION

The present invention relates to data storage systems for data processors and, more specifically, to data storage systems software that automates the process of creating a remote mirror of a relational database or other application.

### BACKGROUND OF THE INVENTION

Typically, in a data processing system a backup subsystem will save a recent copy, version or a portion of one or more data sets on some form of backup data storage device. At present, backup subsystems include magnetic or optical disk drives, tape drives or other memory devices. The backup subsystem will protect against the loss of storage data. For example, if one or more data sets are destroyed, corrupted, deleted or changed then the latest version of those data sets that are stored in a backup subsystem can restore the data sets. Consequently, the backup system minimizes the risk of loss of data. However, the processes of setting up a remote mirroring data process backup system are error prone and time consuming.

The business and/or critical information are frequently stored on external storage servers. Frequently, this information is contained in relational database management systems (RDBMS). Remote data centers and redundant hardware store critical information in order to ensure continuity and prevent data loss in the event of a catastrophic failure. The configuration of the redundant system at a remote location is a complex manual process. For example, the initial manual process consists of configuring the server hardware and software, configuring the storage subsystem(s) and restoring a backup copy of the database.

The storage configuration for large RDBMS systems is very complex and performance of the configuration is critical. The most important factor influencing performance of the configuration is the physical layout of the database on the storage subsystem. After completing the initial configuration of the remote mirror, changes to the remote mirror must occur when there are any changes to the storage allocation at the primary site. This ensures the completeness and viability of the mirrored database copy. In another instance, the overall storage subsystem has not changed but the physical location of one or more components of the storage subsystem has changed. Updating the physical layout of the mirrored database guarantees completeness and viability of the RDBMS.

The current process of setting up a remote mirror involves many steps. These steps include locating all of the volume groups on which that database is located, mapping the volume group to logical volumes, mapping the logical volumes to physical disks, and potentially multi-pathed physical disks, and finally mapping the physical disk to storage subsystem volumes or logical unit numbers (LUNs). The next step is choosing an appropriate target LUN on the target storage subsystem for each of the LUN sources. The target properties include the same type (fixed-block (FB) for open systems or count-key-data (CKD) for mainframes). The target LUN also must be of the same size. The next step physically connects all of the remote mirroring links between the two storage subsystems. Creation of a logical path between each source subsystem and target subsystem occurs over each physical link. The created number of paths is equal to the number of source subsystems multiplied by the number of target subsystems multiplied by the number of physical links. If the logical paths are not created for every physical link, then the remote mirror will not be valid in case of a disaster or link failure. Furthermore, every physical link must be used in order to maximize remote mirroring performance. The final step creates a task to establish remote mirroring from each source to each target. If a user makes a mistake in any of these steps, the remote mirror may not be valid. Furthermore, the user may not discover the mistake until after a disaster, which by that time is too late. Finally, if the configuration changes, the user will have to go through these steps again to reconfigure the mirror.

U.S. Patent Application Publication No. US 2002/0103969 A1, entitled “Mirroring Agent Accessible To Remote Host Computers, And Accessing Remote Data-Storage Devices, VIA A Communications Medium,” discloses a hardware-based mirroring agent that provides a LUN based input/output (I/O) interfaced to remote host computers including mirrored LUNs. The hardware-based mirroring agent is similar to a disk array, but manages and provides to host computers an interface to remote data storage devices. Available to the mirroring agent are the location, addresses, remote data storage devices and/or specifications of mirror relationships to set up and initialize through a configuration and administration interface. The mirroring agent then provides a LUN-based interface to the remote data storage devices via a communications medium to host computers. The host computer can remap remote devices accessible via the communications medium via an automated discovery process, during which updating of the volume manager tables or host I/O tables occur. The mirroring agent establishes and synchronizes groups of mirrored data storage devices using well-known disk mirroring techniques. However, the processes of setting up the hardware-based mirroring agent are error prone and time consuming. It is a manual process and not an automatic process. The mirroring agent requires human intelligence to select the source and target volumes of the mirroring.

It is apparent that there is a need for a method and system that would perform the tasks of remotely automatically mirroring a database and other applications.

### SUMMARY OF THE INVENTION

One aspect of the present invention is a computer for dynamically mirroring a data storage configuration. The computer includes a data interface, a software agent, a communications interface, and a data processor. The data interface is coupled to a data storage medium, and information related to a storage configuration of the first data storage medium is communicated to the computer through the data interface. The software agent is embodied on a computer readable medium, and compares the storage configuration information received through the data interface, termed a first storage configuration, to a second storage configuration. The second storage configuration is received through the communications interface. The software agent uses the second storage configuration to automatically conform the first storage configuration of the first data storage medium to mirror the second storage configuration. This is done at least when a storage configuration parameter differs between the first and the second storage configurations, and possibly more often. The data processor is coupled to the data interface, the communications interface, and the computer readable medium on which the software agent is embodied, and coordinates those various components.

Another aspect of the present invention is a computer program for dynamically mirroring a local assemblage of data. The computer program includes a remote software agent embodied on a computer readable storage medium that is configured to couple to at least one remote storage server and to a local software agent. The remote software agent includes computer instructions for receiving a local storage server configuration including a local storage parameter from the local software agent, for determining a remote storage parameter corresponding to the local storage parameter from the at least one remote storage server, and for configuring the remote storage server in accordance with the received storage parameter to mirror the local storage server configuration.

Another aspect of the present invention is a method of facilitating self-configuring of a remote mirroring system. This method includes at least discovering a primary storage configuration and database layout, and then mapping the discovered primary storage configuration and database layout to create at least one primary storage subsystem volume. The method further includes receiving information concerning a remote storage subsystem, polling the primary storage subsystem volume and a relational database management system (RDBMS), and comparing current information from the primary storage subsystem volume to the received information. At least when certain differences are noted in the comparison, the method includes transmitting storage changes to the remote storage subsystem.

Another aspect of the present invention is a method of automatically extending a storage systems hardware mirroring function. This method includes mapping volumes received from a particular local storage system corresponding to the physical LUNs. The LUNs are those being mirrored to a remote storage subsystem. The method also includes evaluating remote mirror LUNs based on at least one of size, type, performance and reliability to find a suitable LUN. If a suitable LUN is not found, the method includes creating a suitable remote mirror LUN and furthermore, if a volume is to be added, creating a suitable target and mirroring a volume.

These and other aspects of the claimed invention will become apparent from the following description, the description being used to illustrate a preferred embodiment of the claimed invention when read in conjunction with the accompanying drawings.

### BRIEF DESCRIPTION OF THE DRAWINGS

FIG. 1 is a block diagram showing a system that automatically mirrors a database.

FIG. 2 is a flow schematic showing a method of automating the process of creating a remote mirror of a RDBMS.

FIG. 3 is a logical block diagram of a host computer and a backup computer according to the present invention.

### DETAILED DESCRIPTION OF THE INVENTION

While the claimed invention is described below with reference to database volumes of a primary host being mirrored to volumes of a backup host, a practitioner in the art will recognize the principles of the claimed invention are applicable to other applications including those applications as discussed supra.

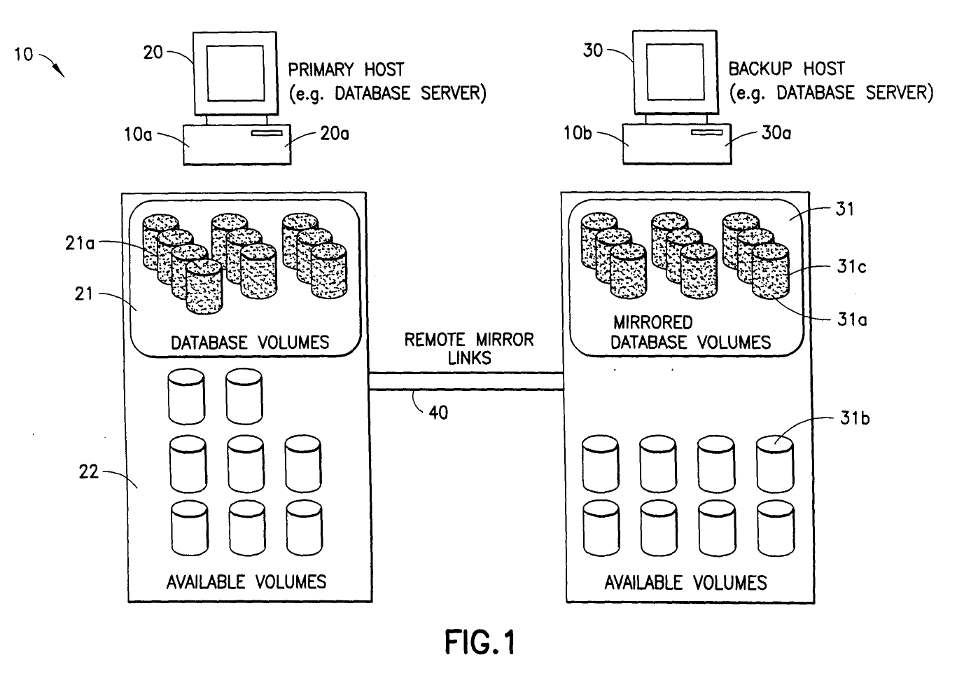

FIG. 1 shows a self-configuring remote mirroring system 10 for dynamic relational applications that includes a local site 20 (primary host) and a remote site 30 (backup host) each containing one or more storage servers. A computer system includes a first external storage server 10a and a second external storage server 10b wherein both process information through a relational database management system (RDBMS). The remote site 30 provides a data backup resource, such as a disaster recovery environment for the local site 20. The first external storage server 10a local system components are duplicated or compatibly configured at the remote site 30 within the second extended storage server 10b. The local site 20 and the remote site 30 have software agents comprising a local agent 20a and a remote agent 30a processing at both the local and remote sites.

The local agent 20a is connected to the first external storage server 10a processing the relational database management system (RDBMS). The local agent discovers the configuration of the first external storage server 10a and then discovers the database layout on it.

The remote agent 30a is connected to the second external storage server 10b processing the RDBMS. The remote agent 30a receives the first external storage server 10a first configuration information 21 from the local agent 20a. The remote agent 30a then creates suitable second configuration information 31 on the second external storage server 10b and begins to mirror the local volumes 21a through one or more remote mirror links 40. The remote mirror logical unit numbers (LUNs) 31a are evaluated for suitability based primarily on size and type criteria. Alternately, the evaluation is extendable to include performance and reliability criteria. If no suitable LUNs 31a are found, the software agents will create one or more secondary LUNs 31b based upon type and size of the first configuration information 21 (local volumes 21a). Furthermore, the software agents can create secondary LUNs 31b based upon a user-defined policy. The remote agent 30a receives the physical database layout 22 from the local agent 20a at the local site 20 and then mirrors the identical configuration on the remote site 30.

After an initial configuration of the first configuration information 21, the local agent 20a processes in the background, periodically checking for changes in storage allocation or database configuration. If the local agent 20a detects changes that require replication at the remote site 30, it sends a message to the remote agent 30a to make the appropriate configuration changes to the second external storage server 10b. For example, changes that require re-configuration include, but are not limited to, a new volume added to the database, volume(s) removed from the database, and the database is moved to different volumes for performance or other reasons. Further changes that require reconfiguration include an error condition that causes a different or backup volume to be used. Alternately, the remote mirror link(s) 40 (path) between the first server 10a and the second server 10b have failed wherein another path must be used or a new path created. The remote agent 20a upon receipt of the configuration change information will effect the required changes on the first and second external storage servers. If no suitable volumes are available, then the local volumes 21a and the remote volumes 31c are creatable based upon, for example, a user-defined policy.

As is understood by the practitioner in the art, the self-configuring remote mirroring system 10, and in particular the software agents, are not limited to databases. In addition, the system 10, and in particular the software agents, are extendable to all of the volumes of a particular host or group of host users, to different applications, to the configuration of the entire storage subsystem, or to a storage area network (SAN).

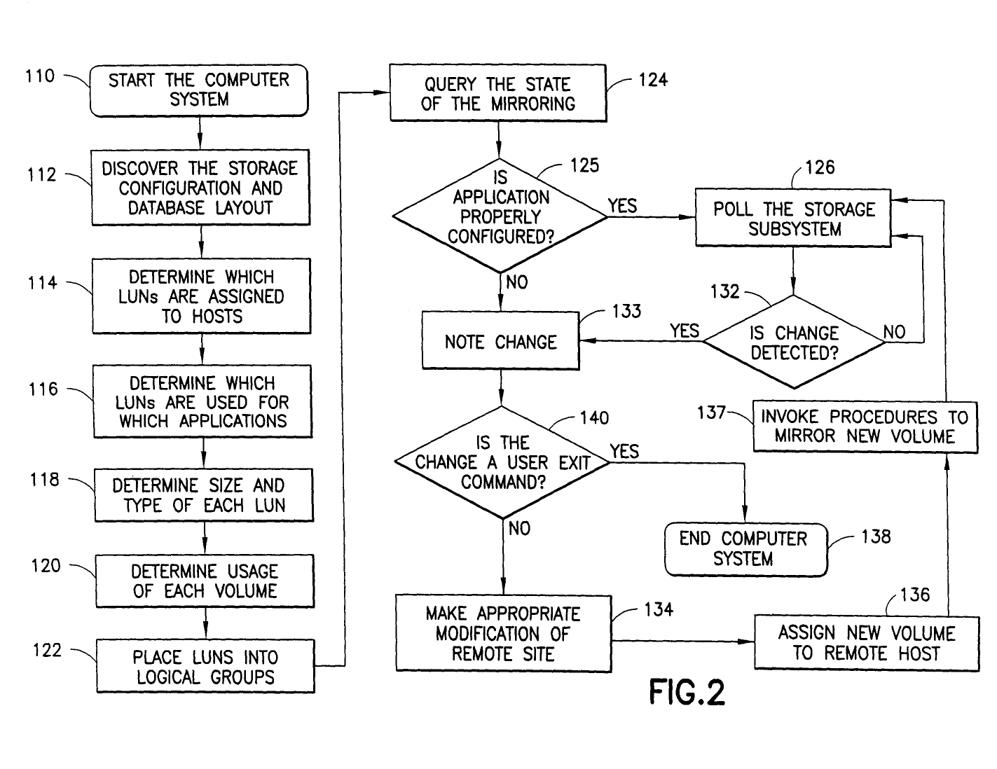

FIG. 2 shows method 100 that describes the automation process that creates a remote mirror of a relational database management system by employing software agents. At step 110, the software agent receives the command to begin the automated mirroring process. At step 112, the software agents discover the storage configuration and the database layout at the local (primary) site. At step 134, software agents relay mapped information to a duplicate remote storage system. At another step 126, software agents monitor the database and storage systems for changes. The software agents then convey storage and/or database changes to the remote storage subsystem. If the user at some point decides that the data no longer needs to be mirrored, he or she can issue a command that causes the mirroring process to stop.

The step 112 discovers the storage configuration and database layout. The storage subsystem layout depends upon the different software tools from the storage system supplier, or alternatively it can use standards-based interfaces (such as the Storage Networking Industry Association's Storage Management Interface (SMI)). The physical database layout is discoverable by collecting information at each layer of the system, that is, database, operating system, volume manager and storage subsystem. At step 114, the software agent determines the logical unit number (LUN) assignment, that is, which LUNs are assigned to which hosts (local site 20 and remote site 30 on FIG. 1). At step 116, the software agent determines which LUNs are being used for a particular database. In the alternative, a database is substitutable for other applications. At step 118, the software agent determines the size and type of each LUN (For example, fixed block, count key data (CKD) or redundant arrays of inexpensive disks (RAID)). At step 120, the software agent determines the usage of each volume, for example, a database log file or database data, and access patterns including but not limited to random, sequential, read and write. Furthermore, user-defined groupings, if present, are determined at step 120.

The steps 114, 116, 118 and 120 are the creation of mapping from the database/operating system container to one or more storage subsystem volumes. The relationship between the storage subsystem volumes and database/operating system containers is a large number to a large number. For example, a single container includes multiple storage volumes and a single storage volume is useable in multiple database/operating system containers. Furthermore, subsystem volumes are mapable to corresponding logical unit numbers LUNs at step 122. The LUNs are placed into logical groupings. For example, logical groupings include but are not limited to all volumes used by a database, all volumes used by a particular host, user-defined groupings or all volumes used for a set of business applications.

The step 134, the software agent relays the mapped information to a duplicate remote storage subsystem. A software agent (local agent 20a) that processes on a first external storage server 10a (FIG. 1) collects the first configuration information 21 and forwards it to a remote agent 30a. The remote agent processes in a similar manner on a second external storage server 10b (FIG. 1). Initially, the second external storage server (remote storage subsystem) information is identical to the first external storage server (primary storage subsystem) information. The local agent, at step 126, periodically polls the storage subsystem and the RDBMS comparing, at step 132, whether a change has occurred with current information with the previously stored information. At step 134, the remote agent conveys storage and/or database changes to the remote storage subsystem. If the local agent detects changes affecting the physical storage configuration, the changes proceed to the remote agent and are then applied to the remote storage system.

At step 124 the software agent queries the state of the mirroring. If the applications are already properly configured to perform mirroring, then at step 125 a decision is made to go to the polling mode and poll the storage subsystem at step 126. This allows the software agent to be used with existing mirroring configurations as well as new configurations. At step 125, if the application is not properly configured to perform mirroring then the software agent directs the process to step 133 where the change is noted.

The software agent processes continuously, polling for changes in storage allocation and application configuration. At step 132, the software agent determines if a change is detected in the local storage subsystem. If no change is detected the software agent proceeds back to step 126 and polls the storage sub-system. However, if a change is detected to the local storage subsystem at step 132 then a change is noted at step 133. For example, adding a new volume to the database is detected and the software agent identifies and understands the usage of a new volume. Once the change is noted at step 133, the software agent will act appropriately at step 140 depending on the change. If the change is a command to stop mirroring, then the process ends at step 138. Otherwise, the software agent at step 134 makes the appropriate modification on the remote systems. Then the software agent at step 136 will assign the new volume to the remote host and/or format the volume. In addition, at step 136 the software agent will add the new volume to the operating system logical volume and update the database and/or application configuration. Once step 136 is complete the software agent proceeds to step 137 invoking procedures to mirror the new volumes. When step 137 is complete the software agent returns to the polling mode in step 126 repeating the process of automatically self-configuring a remote mirroring of a dynamic relational database or application.

By way of a summary, FIG. 2 shows the method 100 that includes the automatic extending of storage systems hardware mirroring functions to include host software, different functional applications and databases. At steps 114, 116, 118 and 120, mapping of the volumes currently used by a particular host or application to the corresponding physical LUN occurs. Polling, mapping and comparing of the mapped LUNs to a remote storage subsystem occur at steps between steps 114 and 132. The step 118 evaluates remote mirror LUNs for suitability based primarily on size and type criteria. Alternately, the evaluation is extendable to include performance and reliability criteria. If no suitable LUN is findable, at step 124, the method will create a suitable LUN based upon size and type criteria and a user-defined policy. In the alternate, if there is addition of a volume at the local (primary) site database the method will automatically find or create a suitable target and begin mirroring that volume. Similarly, if data moves to a different location or moves from the local (source) database, the old volume does not need mirroring and the method performs the mirroring function automatically.

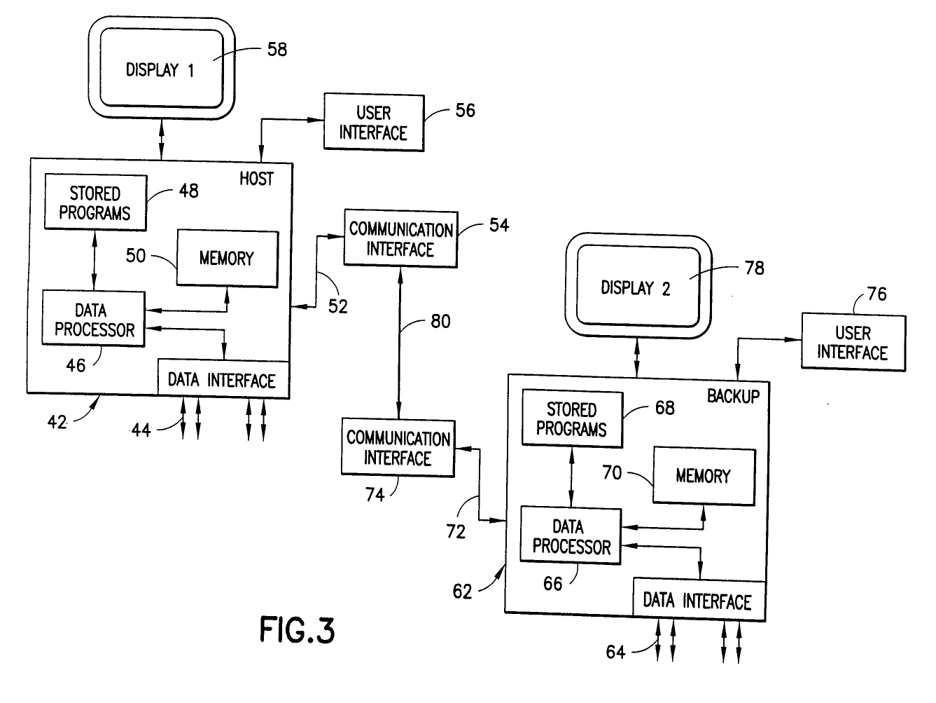

FIG. 3 is a logical block diagram of a source computer 42 that includes a first data interface 44 that couples the source computer 42 to a source data storage that may include a series of source volumes for storing data to be backed up. The source computer 42 also includes a first data processor 46, one or more first stored programs 48 that are stored on one or more computer readable storage mediums, and a first memory 50 that may include volatile and/or non-volatile memory. The source computer 42 further includes a source communications interface 52 for receiving and transmitting data such as configuration information relating to the source data storage or to a backup data storage, according to the present invention. When the source data storage is to be reconfigured based on the configuration of the backup data storage, the source computer 42 may receive configuration information from the backup computer 62. Interconnects between the first processor 46, the stored first programs 48, the first memory 50, and the first data interface 44 depicted in FIG. 3 are illustrative but not limiting. The source communication interface 54 may be coupled to a first communication interface 54 such as a modem or any suitable connection, and the source computer 42 may further include a first user interface 56 such as a keyboard, and a first display 58. However, certain embodiments of the present invention need not include the first communication interface 54, such as where the source computer 42 and a backup computer 62 are connected directly (such as when the source 42 and backup 62 are located at the same physical facility) rather than over a local, regional or global network. Similarly, the first user interface 56 and first display 58 are not essential due to the automated nature of the present invention, though they may be desirable for entry and confirmation of user-defined parameters.

The backup computer 62 includes a data interface 64 that couples the backup computer 62 to a backup data storage that may include a series of backup volumes for storing data to be backed up. The backup data storage need not be of the same model or type as the source data storage, as the present invention only requires mirroring of the configuration. Where the backup and source data storages are not the same model and/or type, the respective data interfaces 44, 64 may not be identical physically, though they function similarly in transferring configuration data to and from each other through the source and backup computers 42, 62.

The backup computer 62 also includes a second data processor 66, one or more second stored programs 68 that are stored on one or more computer readable storage mediums, and a second memory 70 that may include volatile and/or non-volatile memory. The backup computer 62 further includes a backup communications interface 72 for receiving and transmitting data such as configuration information relating to the source data storage and the backup data storage, according to the present invention. Interconnects between the second processor 66, the stored second programs 68, the second memory 70, and the second data interface 64 depicted in FIG. 3 are also illustrative but not limiting. The backup communication interface 74 may be coupled to a second communication interface 74 such as a modem, and the backup computer 62 may further include a second user interface 76 such as a keyboard, and a second display 78. However, certain embodiments of the present invention need not include the second communication interface 74, such as embodiments for the example noted above. Similarly, the second user interface 76 and the second display 78 are not essential due to the automated nature of the present invention.

The source computer 42 and the backup computer 62 are coupled to one another via one or more communications links 80, which may be through the internet, an intra-net, a local area network, a piconetwork, an infrared or microwave link, a remote mirror link 40 as previously described, or any other viable communications means, whether wired, wireless, or a combination.

Operation of the source computer 42 and the backup computer 62 is as described above, wherein first and second agents may be resident in the source and remote stored programs areas 48, 68.

While there has been illustrated and described what is at present considered to be a preferred embodiment of the claimed invention, it will be appreciated that numerous changes and modifications are likely to occur to those skilled in the art. It is intended in the appended claims to cover all those changes and modifications that fall within the spirit and scope of the claimed invention.

1. A computer for dynamically mirroring a data storage configuration comprising:
a data interface coupled to a data storage medium through which information relating to a first storage configuration of the first data storage medium is communicated;
a software agent embodied on a computer readable medium for comparing the first storage configuration to a second storage configuration, and at least when a storage configuration parameter differs between the first and the second storage configurations, for one of automatically conforming the first storage configuration to mirror the second storage configuration and automatically outputting a change to be made to conform the second storage configuration to mirror the first storage configuration;
a communications interface through which one of the second storage configuration is received and the change to be made is transmitted; and
a data processor for executing the software agent.

2. The computer of claim 1 wherein the storage configuration parameter is selected from the group: a database layout; a logical unit number (LUN) type; a LUN size; a measure of LUN performance; and a measure of LUN reliability.

3. The computer of claim 1 wherein the software agent is configured to one of output the first storage configuration to and receive the second storage configuration from a second software agent through the communications interface.

4. The computer of claim 1 wherein conforming the first storage configuration to mirror the second storage configuration comprises creating a secondary LUN based on at least one of a LUN type and a LUN size received through the communications interface when a primary LUN of the data storage medium is unsuitable.

5. The computer of claim 1 wherein the software agent receives the first storage configuration from a relational database management computer program.

6. A computer program for dynamically mirroring a local assemblage of data comprising:
a remote software agent embodied on a computer readable storage medium and configured to couple to at least one remote storage server and to a local software agent, wherein the remote software agent comprises computer instructions for:
receiving a local storage server configuration including a local storage parameter from the local software agent;
determining a remote storage parameter corresponding to the local storage parameter from the at least one remote storage server; and
configuring the remote storage server in accordance with the received storage parameter to mirror the local storage server configuration.

7. The computer program of claim 6 wherein the remote software agent further comprises computer instructions for comparing the received local storage parameter to the determined remote storage parameter.

8. The computer program of claim 6 wherein the storage parameter is at least one of a database layout, a logical unit number (LUN) type, a LUN size, a measure of LUN performance, and a measure of LUN reliability.

9. The computer program of claim 6 wherein the remote software agent further comprises computer instructions for communicating a message that the remote storage server conforms to the local storage server.

10. The computer program of claim 6 wherein the remote software agent further comprises computer instructions for creating a secondary remote mirror LUN, based on at least one of LUN type and LUN size received from the local software agent, when a primary remote mirror LUN is not suitable.

11. The computer program of claim 6 wherein the remote software agent operates in cooperation with the at least one remote storage server using a relational database management system.

12. The computer program of claim 6 further comprising the local software agent embodied on a computer readable storage medium and configured to couple to at least one local storage server and to the remote software agent.

13. The computer program of claim 12 wherein the local software agent comprises computer instructions for:
polling a configuration of the local storage server;
determining the local storage parameter of the local storage server; and
communicating the local storage server configuration including the local storage parameter to the remote software agent.

14. The computer program of claim 13 wherein the computer instructions for communicating the local storage parameter to the remote software agent comprise instructions to initiate said communicating when the local software agent detects a change in a local storage server configuration.

15. The computer program of claim 14 wherein the change in the local storage server configuration is at least one of a new volume added, an existing volume removed, a change in volume, and a failure of a remote mirror link between the local storage server and the remote storage server.

16. The computer program of claim 12 wherein the local software agent operates in cooperation with the at least one local storage server using a relational database management system.

17. A method of facilitating self-configuring of a remote mirroring system comprising:
discovering a primary storage configuration and database layout;
mapping said primary storage configuration and database layout creating at least one primary storage subsystem volume;
receiving information concerning a remote storage subsystem;
polling said primary storage subsystem volume and a relational database management system (RDBMS);
comparing current information from said primary storage subsystem volume to the received information; and
transmitting storage changes to said remote storage subsystem.

18. The method of claim 17, wherein said storage changes are substitutable for database changes.

19. A method of automatically extending a storage systems hardware mirroring function, comprising:
mapping volumes received from a particular local storage system corresponding to physical LUNs, said physical LUNs being mirrored to a remote storage subsystem;
evaluating remote mirror LUNs based on at least one of size, type, performance and reliability to find a suitable LUN;
creating a suitable remote mirror LUN if a suitable LUN is not found; and
creating a suitable target and mirroring a volume if a volume is to be added.

20. The method of claim 19 wherein said mapping further includes querying the state of the mirroring to determine a proper configuration for an application.

21. The method of claim 19, wherein said evaluating determines a proper modification at said remote storage subsystem that includes invoking procedures to mirror at least one new volume and assigning the at least one new volume to said remote storage subsystem.

22. The method of claim 21, wherein said modification further includes adding at least one new volume to an operating logical volume, updating a remote storage subsystem and invoking procedures to mirror said at least one new volume.

23. A computer configured for coupling to a data storage system comprising:
means for discovering a first storage configuration and database layout of the data storage system;
means for mapping said first storage configuration and database layout creating at least one first storage subsystem volume;
means for receiving information concerning a second storage subsystem;
means for polling said first storage subsystem volume and a relational database management system (RDBMS);
means for comparing current information from said first storage subsystem volume to the received information; and
means for transmitting storage changes to said second storage subsystem.

24. A computer configured for coupling to a first data storage system comprising:
means for mapping volumes received from a first data storage system corresponding to physical LUNs, said physical LUNs being mirrored in a second storage subsystem;
means for evaluating the mirrored LUNs in the second storage subsystem based on at least one of size, type, performance and reliability to find a suitable LUN;
means for creating a suitable mirror LUN in the second storage subsystem if a suitable LUN is not found in the second storage subsystem; and
means for creating a suitable target in the second storage subsystem and mirroring a volume in the second storage subsystem if a volume is to be added.
